(19) United States
(12) Patent Application Publication
(10) Pub. No.: US 2025/0290673 A1
(43) Pub. Date: Sep. 18, 2025

(54) REFRIGERATOR EMPLOYING ROTATING MAGNETIC ARRAY DEVICE AND MAGNETIC COOLING APPARATUS

(71) Applicant: SAMSUNG ELECTRONICS CO., LTD., Suwon-si (KR)

(72) Inventor: Noriyoshi NISHIYAMA, Suwon-si (KR)

(21) Appl. No.: 19/090,347

(22) Filed: Mar. 25, 2025

Related U.S. Application Data
(63) Continuation of application No. PCT/KR2025/003127, filed on Mar. 10, 2025.

(30) Foreign Application Priority Data
Mar. 13, 2024 (JP) 2024-039201

(51) Int. Cl. F25B 21/00

(52) U.S. Cl. CPC F25B 21/00; F25B 2321/0022

(57) ABSTRACT

A refrigerator includes a body provided with a storage chamber, and a cold air supply apparatus provided with a rotating magnetic array device and a cold air extracting device for extracting the cold energy, and supplying the cold energy to the storage chamber. The rotating magnetic array device includes a magnetic field generator including magnetic poles and being rotatable about a rotary shaft, and magnetic material portions including heat generators for generating heat energy and cold energy according to rotation of the magnetic field generator. The magnetic material portions are arranged on a circumference based on the rotary shaft to simultaneously include a magnetic material portion facing a center of one of the magnetic poles, a second magnetic material portion facing one of the magnetic poles and not facing a center of the magnetic pole, and a third magnetic material portion facing a space between two of the magnetic poles.

### CROSS-REFERENCE TO RELATED APPLICATIONS

This application is a continuation application of International Application No. PCT/KR2025/003127 designating the United States, filed on Mar. 10, 2025, in the Korean Intellectual Property Receiving Office, which claims priority from Japanese Patent Application No. 2024-039201, filed on Mar. 13, 2024, in the Japan Intellectual Property Office, the disclosures of which are hereby incorporated by reference herein in their entireties.

### TECHNICAL FIELD

The disclosure relates to a refrigerator employing a rotating magnetic array device and a magnetic cooling apparatus.

### BACKGROUND ART

Japanese Laid-open Patent No. 2018-17484 discloses a magnetic refrigeration apparatus comprising a magnetic field generator that may rotate, a heat generator installed on an outer circumference side of the magnetic field generator, and a yoke installed on an outer circumferential side of the heat generator. The magnetic field generator is provided with a plurality of permanent magnets arranged in a Halbach array in a rotating direction. The heat generator includes a plurality of ducts arranged in a rotating direction, and a plurality of magnetocaloric portions respectively accommodated in the plurality of ducts and each including a magnetocaloric material.

### Technical Solution

According to an aspect of the disclosure, a refrigerator includes a main body provided with at least one storage chamber, and a cold air supply apparatus supplying cold energy to the storage chamber. The cold air supply apparatus includes a rotating magnetic array device, and a cold energy extracting device for extracting the cold energy generated by the rotating magnetic array device. The rotating magnetic array device includes a magnetic field generator being rotatable about a rotary shaft, and a plurality of magnetic material portions including a plurality of heat generators generating heat energy and cold energy according to rotation of the magnetic field generator. The magnetic field generator includes a plurality of magnetic poles generating magnetic fields. The plurality of magnetic material portions are arranged on a circumference based on the rotary shaft, so as to simultaneously include a first magnetic material portion facing a center of one of the plurality of magnetic poles, a second magnetic material portion facing one of the plurality of magnetic poles and not facing a center of the magnetic pole, and a third magnetic material portion facing a space between two of the plurality of magnetic poles.

According to an aspect of the disclosure, the magnetic cooling apparatus includes the rotating magnetic array device, and the cold energy extracting device for extracting the cold energy when one of the plurality of heat generators generates cold energy.

### DESCRIPTION OF DRAWINGS

FIG. 1 is a diagram showing an example of a rotating magnetic array device according to an embodiment of the disclosure;

FIG. 2 is a diagram showing an example of magnetic circuits formed when a magnetic pole faces a magnetic material in the rotating magnetic array device of FIG. 1, according to an embodiment of the disclosure;

FIG. 3 is a graph showing an example of a relationship between a magnetic susceptibility of a heat generator and a torque ratio when a dummy is not arranged;

FIG. 4 is a graph showing an example of a relationship between a magnetic susceptibility of the heat generator and a magnetization rate of a dummy where a torque is minimum.

FIG. 5 shows a torque ratio when four heat generators and nineteen dummies are arranged and the relationship of FIG. 4 is applied;

FIG. 6 is a graph showing an example of a relationship between the magnetic susceptibility of the heat generator and the magnetic susceptibility of the dummy with respect to a torque ratio;

FIG. 7 is a diagram showing an example of a rotating magnetic array device in which thirteen magnetic material portions are arranged;

FIG. 8 is a diagram showing an example of a rotating magnetic array device in which sixteen magnetic material portions are arranged;

FIG. 9 is a diagram showing an example of a rotating magnetic array device in which seventeen magnetic material portions are arranged;

FIG. 10 is a diagram showing an example of a rotating magnetic array device in which twenty-four magnetic material portions are arranged;

FIG. 11 is a graph showing cogging torque waveforms with respect to the number of magnetic material portions;

FIG. 12 is a diagram showing a relationship between the number of magnetic material portions and a cogging torque ratio;

FIG. 13 is a diagram showing a vicinity of a central magnetic pole in detail;

FIG. 14 is a diagram showing a part of the rotating magnetic array device when a ½ front dimension of a central magnetic pole is 2 mm;

FIG. 15 is a diagram showing a part of the rotating magnetic array device when a ½ front dimension of a central magnetic pole is 10 mm;

FIG. 16 is a diagram showing a part of the rotating magnetic array device when a ½ front dimension of a central magnetic pole is 12 mm;

FIG. 17 is a diagram showing a part of the rotating magnetic array device when a ½ front dimension of a central magnetic pole is 18 mm;

FIG. 18 is a graph showing a relationship between the ½ front dimension of the central magnetic pole and a torque ratio;

FIG. 19 is a graph showing a relationship between the ½ front dimension of the central magnetic pole and a magnetic flux density ratio;

FIG. 20 is a schematic block diagram of a magnetic refrigeration system according to an embodiment of the disclosure; and

FIG. 21 is a schematic block diagram of a refrigerator according to an embodiment of the disclosure.

### MODE FOR INVENTION

It should be appreciated that various embodiments of the disclosure and the terms used therein are not intended to limit the technological features set forth herein to particular embodiments and include various changes, equivalents, or replacements for a corresponding embodiment.

Regarding the description of the drawings, like reference numerals may be used for like components.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

The term “and/or” includes a combination of a plurality of related described components or any one component among the plurality of related described components.

As used herein, such terms as “1st” and “2nd,” or “first” and “second” may be used to simply distinguish a corresponding component from another, and does not limit the components in other aspect (e.g., importance or order).

In addition, terms such as ‘front surface’, ‘rear surface’, ‘upper surface’, ‘lower surface’, ‘side surface’, ‘left side’, ‘right side’, ‘upper portion’, and ‘lower portion’ used in the disclosure are defined based on the drawings, and the shape and position of each component are not limited by the terms.

It is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

When a component is referred to as being “connected to”, “combined with”, “supported by”, or “in contact with” another component, this includes not only a case where the components are connected to, combined with, supported by, or in contact with each other in a direct manner, but also a case where the components are connected to, combined with, supported by, or in contact with each other in an indirect manner via a third component.

When a component is referred to as being positioned “on” another component, this includes not only a case where a component is in contact with another component, but also a case where another component exists between the two components.

Most of freezers (or coolers) used in refrigerators, etc. adopt a vapor compression type refrigerating (or cooling) cycle using a gas refrigerant such as an alternative Freon-gas, etc., and influences of discharging of the alternative Freon-gas, etc. on global warming has been concerned. Under the above circumstance, a magnetic freezing (or cooling) technique using a magnetocaloric effect (MCE) is being highlighted.

The MCE denotes an effect of generating heat when a magnet approaches a magnetic substance and decreasing a temperature when the magnet is away from the magnetic substance. The magnetic freezing technique is a technique generating low-temperature by using the MCE. The magnetic freezing technique has historically been researched and developed as a technique that generates ultra-cold or cryogenic temperatures that are difficult to generate with vapor compression refrigeration cycles. In a high temperature region, disorder of electron spin is large, and an extremely strong magnetic field is necessary for obtaining a large temperature change. In a room temperature region, the MCE itself degrades. As a unit for addressing the above issues, an active magnetic refrigeration (AMR) has been developed.

In the AMR, a magnetic substance is accommodated in a magnetocaloric unit so as to secure a flow path of a heat transfer medium. Entrances of the heat transfer medium are provided at opposite ends of the magnetocaloric unit. Then, four processes including (1) applying a magnetic field to the magnetic substance, (2) transporting heat energy toward the high temperature side via the heat transfer medium, (3) removing magnetic field from the magnetic substance, and (4) transporting cold energy toward the low temperature side via the heat transfer medium, are repeatedly performed. The AMR obtains a temperature gradient gradually increasing because the cold energy generated due to the magnetic refrigeration effect is accumulated in the magnetic substance by repeating the above processes.

In order to apply the magnetic freezer (or cooler) to a household refrigerator, a coefficient of performance (COP) needs to be improved. To this end, a magnetic array capable of repeatedly generating high magnetic flux density difference and reducing a mechanical input (energy provided to a motor for rotating the magnetic array) is necessary.

The disclosure provides a refrigerator employing a rotating magnetic array device that is capable of reducing a mechanical input by optimizing arrangements of a plurality of magnetic poles that are rotated and a plurality of magnetic material portions corresponding to the plurality of magnetic poles and reducing the torque ripple of a motor rotating the plurality of magnetic poles through an increase to a higher order, and a magnetic cooling apparatus. It will be appreciated by one of ordinary skill in the art that that the objectives and effects that could be achieved with the disclosure are not limited to what has been particularly described above and other objectives of the disclosure will be more clearly understood from the following detailed description.

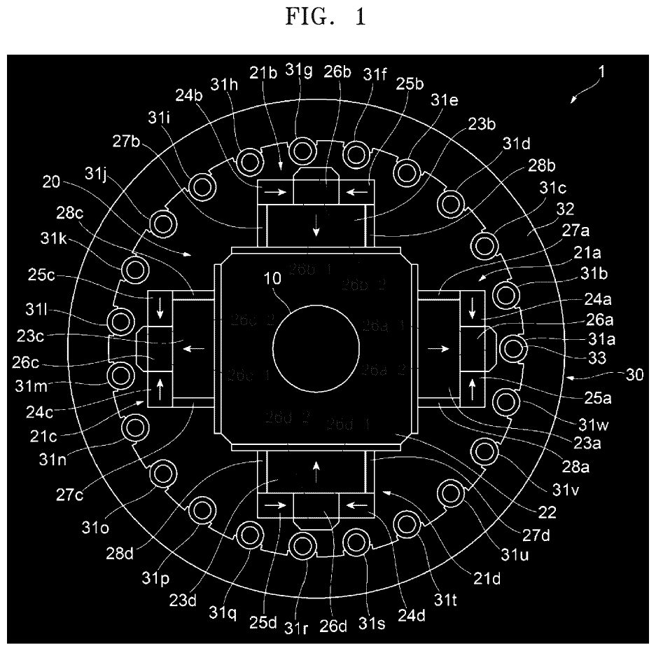

FIG. 1 is a schematic block diagram of a rotating magnetic array device 1 according to an embodiment of the disclosure. Referring to FIG. 1, the rotating magnetic array device 1 may include a rotary shaft 10, a rotor 20, and a stator 30.

The rotary shaft 10 may be, for example, a shaft connected to a motor (not shown). The rotary shaft 10 is rotated by supplying a motor current to the motor.

The rotor 20 may rotate about the rotary shaft 10. The rotor 20 may be a magnetic field generator that includes a plurality of magnetic poles and generates a magnetic field by rotating about the rotary shaft 10. In an embodiment of the disclosure, the rotor 20 may include four magnetic poles 21a-21d generating magnetic fields. In FIG. 1, four magnetic poles are indicated separately by reference numerals 21a, 21b, 21c, and 21d, but the four magnetic poles may be collectively indicated by a reference numeral 21. FIG. 1 shows four magnetic poles 21, but the number of magnetic poles 21 is not limited thereto. For example, the rotor 20 may include even-numbered magnetic poles 21, e.g., two, six, etc., and may include an arbitrary number of magnetic poles 21.

The rotor 20 may include a first yoke 22. The first yoke 22 may be arranged inside the magnetic poles 21a-21d in a radial direction. The first yoke 22 may pass magnetic lines of the magnetic field generated by the rotor 20 from the inner circumferential side of the magnetic poles 21a-21d. The first yoke 22 may include, for example, a ferromagnetic substance having a high relative permeability, referred to as SS400 by Japanese industrial standards (JIS).

The stator 30 may include a plurality of magnetic material portions, for example, 23 magnetic material portions 31a-31w and a second yoke 32. In FIG. 1, the plurality of magnetic material portions are separately indicated by reference numerals 31a-31w, but twenty-three magnetic material portions may be collectively indicated by a reference numeral 31. Also, FIG. 1 shows twenty-three magnetic material portions 31, but the number of the magnetic material portions 31 is not limited thereto. For example, the number of magnetic material portions 31 may be less than twenty-three or greater than twenty-three. The number of magnetic material portions 31 is described in detail later.

The magnetic material portions 31a-31w are arranged on a circumference centering around the rotary shaft 10 along a rotating direction of the rotor 20, that is, rotating directions of the magnetic poles 21a-21d. Each of the magnetic material portions 31a-31w accommodates a magnetocaloric unit 33. The magnetocaloric unit 33 includes a magnetocaloric material (MCM) having a temperature varying depending on a variation in the intensity of the magnetic field applied by the rotor 20. When the rotor 20 rotates, the plurality of magnetocaloric units 33 generate heat energy or cold energy. That is, when increase/decrease in the intensity of the magnetic field applied to each of the plurality of magnetocaloric units 33 by the rotor 20 rotating about the rotary shaft 10 repeatedly occur, the temperature of the plurality of magnetocaloric units 33 repeatedly increases/decreases. Here, the plurality of magnetocaloric units 33 generate heat energy or cold energy. Therefore, twenty-three magnetic material portions 31a-31w are a plurality of heat generators generating heat energy and cold energy according to the rotation of the magnetic field generator, that is, the rotor 20. The plurality of magnetic material portions 31 are arranged circularly on an outside of the magnetic field generator, that is, the rotor 20.

The second yoke 32 is arranged on the outer sides of the plurality of magnetic material portions 31 and passes lines of magnetic force of the magnetic field generated by the rotor 20 at the outer circumferential sides of the magnetic material portions 31a-31w based on the rotary shaft 10. The second yoke 32 may include, for example, a ferromagnetic substance having a high relative permeability such as a steel material referred to as SS400 by JIS, etc. Accordingly, because the lines of magnetic force pass through the second yoke 32 at the outer circumferential sides of the magnetic material portions 31, the magnetic field generated by the rotor 20 may be prevented or suppressed from dispersing to the outer circumferential sides of the magnetic material portions 31.

Each of the plurality of magnetic poles 21 may include a magnet arrangement including a plurality of magnets having different magnetization directions, and a central magnetic pole. Each of the plurality of magnetic poles 21 may further include a plurality of non-magnetic members supporting the plurality of magnets and the central magnetic pole with respect to the first yoke 22. In each of the plurality of magnetic poles 21a, 21b, 21c, and 21d, the plurality of magnets are distinguished by adding alphabets a, b, c, and d to reference numerals 23, 24, and 25, the central magnetic pole is distinguished by adding alphabets a, b, c, and d to reference numeral 26, and the plurality of non-magnetic members are distinguished by adding alphabets a, b, c, and d to reference numerals 27 and 28. When they are described without being discriminated, a plurality of magnets are indicated by reference numerals 23, 24, and 25, the central magnetic pole is indicated by reference numeral 26, and the plurality of non-magnetic members are indicated by reference numerals 27 and 28.

For example, the plurality of magnets may include first, second, and third magnets 23, 24, and 25. The first, second, and third magnets 23, 24, and 25 have different magnetization directions. The first magnet 23 has a magnetization direction that is a radial direction based on the rotary shaft 10. The second and third magnets 24 and 25 may be arranged to face each other on the outer circumferential side of the first magnet 23 in a circumferential direction based on the rotary shaft 10. The second and third magnets 24 and 25 have a magnetization direction that is substantially circumferential direction. The magnetization directions of the second and third magnets 24 and 25 are opposite to each other. The magnetization directions of the second and third magnets 24 and 25 are circumferential directions toward the central magnetic pole 26. The first, second, and third magnets 23, 24, and 25 may include, for example, permanent magnets.

The central magnetic pole 26 includes a magnetic substance. The central magnetic pole 26 may be at least partially located on the outer side of the magnet arrangement in the radial direction. That is, the central magnetic pole 26 may at least partially protrude toward the magnetic material portions 31 in the radial direction from the magnet arrangement. For example, the central magnetic pole 26 may be located on the outer side with respect to the first magnet 23 that is at the center, from among the plurality of magnets 23, 24, and 25, in the radial direction and between the second and third magnets 24 and 25. The central magnetic pole 26 is arranged adjacent to the magnetic material portions 31 than the first, second, and third magnets 23, 24, and 25. The central magnetic pole 26 may include a first part located between the second magnet 24 and the third magnet 25 and opposed to the first magnet 23, and a second part protruding from the first part toward the magnetic material portions 31. The first part and the second part may be separate members or may be integrated with each other.

For example, the plurality of non-magnetic members may include first and second non-magnetic members 27 and 28. The first non-magnetic member 27 is located on one side of the first magnet 23 in the circumferential direction, and may support an overhang portion of the second magnet 24 protruding toward one side in the circumferential direction with respect to the first magnet 23. The second non-magnetic member 28 is located on the other side of the first magnet 23 in the circumferential direction, and may support an overhang portion of the second magnet 24 protruding toward the other side in the circumferential direction with respect to the first magnet 23.

Hereinafter, a structure of each of the magnetic poles 21a-21d is described according to an embodiment. The magnetic pole 21a may include first, second, and third permanent magnets 23a, 24a, and 25a, a central magnetic pole 26a, and first and second non-magnetic members 27a and 28a. The magnetic pole 21b may include first, second, and third permanent magnets 23b, 24b, and 25b, a central magnetic pole 26b, and first and second non-magnetic members 27b and 28b. The magnetic pole 21c may include first, second, and third permanent magnets 23c, 24c, and 25c, a central magnetic pole 26c, and first and second non-magnetic members 27c and 28c. The magnetic pole 21d may include first, second, and third permanent magnets 23d, 24d, and 25d, a central magnetic pole 26d, and first and second non-magnetic members 27d and 28d.

In FIG. 1, magnetization directions of the permanent magnets 23a, 24a, 25a, 23b, 24b, 25b, 23c, 24c, 25c, 23d, 24d, and 25d are indicated by bold arrows. As shown in FIG. 1, the magnetization directions of the first, second, and third permanent magnets 23a, 24a, and 25a are different from each other. The first, second, and third permanent magnets 23b, 24b, and 25b have different magnetization directions. The first, second, and third permanent magnets 23c, 24c, and 25c have different magnetization directions. The first, second, and third permanent magnets 23d, 24d, and 25d have different magnetization directions.

The central magnetic pole 26a is a magnetic pole formed of a magnetic substance that is arranged on the outer side of the first, second, and third permanent magnets 23a, 24a, and 25a, that is, at the side of the magnetic material portions 31. In addition, in FIG. 1, the central magnetic pole 26a includes a first part 26a-1 that is defined by the parts coming into contact with the first, second, and third permanent magnets 23a, 24a, and 25a, that is, a right side of the first permanent magnet 23a, a lower side of the second permanent magnet 24a, an upper side of the third permanent magnet 25a, and a line connecting right sides of the second and third permanent magnets 24a and 25a, and a second part 26a-2 protruding from the first part 26a-1 toward the magnetic material portion 31. The first part 26a-1 and the second part 26a-2 may be separate members or may be integrated with each other. The central magnetic pole 26b is a magnetic pole formed of a magnetic substance that is arranged on the outer side of the first, second, and third permanent magnets 23b, 24b, and 25b, that is, at the side of the magnetic material portions 31. The central magnetic pole 26b includes a first part 26b-1 coming into contact with the first, second, and third permanent magnets 23b, 24b, and 25b, and a second part 26b-2 protruding from the first part 26b-1 toward the magnetic material portion 31. The first part 26b-1 and the second part 26b-2 may be separate members or may be integrated with each other. The central magnetic pole 26c is a magnetic pole formed of a magnetic substance that is arranged on the outer side of the first, second, and third permanent magnets 23c, 24c, and 25c, that is, at the side of the magnetic material portions 31. The central magnetic pole 26c includes a first part 26c-1 coming into contact with the first, second, and third permanent magnets 23c, 24c, and 25c, and a second part 26c-2 protruding from the first part 26c-1 toward the magnetic material portion 31. The first part 26c-1 and the second part 26c-2 may be separate members or may be integrated with each other. The central magnetic pole 26d is a magnetic pole formed of a magnetic substance that is arranged on the outer side of the first, second, and third permanent magnets 23d, 24d, and 25d, that is, at the side of the magnetic material portions 31. The central magnetic pole 26d includes a first part 26d-1 coming into contact with the first, second, and third permanent magnets 23d, 24d, and 25d, and a second part 26d-2 protruding from the first part 26d-1 toward the magnetic material portion 31. The first part 26d-1 and the second part 26d-2 may be separate members or may be integrated with each other.

The first non-magnetic members 27a-27d respectively support overhang portions of the second permanent magnets 24a-24d, and the second non-magnetic members 28a-28d respectively support overhang portions of the third permanent magnets 25a-25d. The first and second non-magnetic members 27a-27d and 28a-28d may be formed of, for example, aluminum, resin, etc.

The first permanent magnet 23a of the magnetic pole 21a has an N-pole and an S-pole. The N-pole of the first permanent magnet 23a is arranged on the outer circumferential side of the first permanent magnet 23a in the radial direction based on the rotary shaft 10, and the S-pole of the first permanent magnet 23a is arranged on the inner circumferential side of the first permanent magnet 23a in the radial direction based on the rotary shaft 10. The first permanent magnet 23a is an example of a first magnet that is arranged on the side of the rotary shaft 10 with respect to the central magnetic pole 26a based on the radial direction and has a magnetization direction in the radial direction.

The second and third permanent magnets 24a and 25a of the magnetic pole 21a respectively have N-poles and S-poles. The N-poles of the second and third permanent magnets 24a and 25a are arranged on the side of the central magnetic pole 26a in the circumferential direction based on the rotary shaft 10, and the S-poles of the second and third permanent magnets 24a and 25a are arranged on the side opposite to the central magnetic pole 26a in the circumferential direction based on the rotary shaft 10. The second and third permanent magnets 24a and 25a are examples of second and third magnets that are arranged with the central magnetic pole 26a interposed therebetween in the circumferential direction based on the rotary shaft 10 and have the magnetization directions in the circumferential direction toward the central magnetic pole 26b.

The first permanent magnet 23b of the magnetic pole 21b has an N-pole and an S-pole. The N-pole of the first permanent magnet 23b is arranged on the inner circumferential side of the first permanent magnet 23b in the radial direction based on the rotary shaft 10 and the S-pole of the first permanent magnet 23b is arranged on the outer circumferential side of the first permanent magnet 23b in the radial direction based on the rotary shaft 10. The first permanent magnet 23b is an example of a first magnet that is arranged on the side of the rotary shaft 10 with respect to the central magnetic pole 26b based on the radial direction and has a magnetization direction in the radial direction.

The second and third permanent magnets 24b and 25b of the magnetic pole 21b respectively have N-poles and S-poles. The N-poles of the second and third permanent magnets 24b and 25b are arranged on the side of the central magnetic pole 26b in the circumferential direction based on the rotary shaft 10, and the S-poles of the second and third permanent magnets 24b and 25b are arranged on the side opposite to the central magnetic pole 26b in the circumferential direction based on the rotary shaft 10. The second and third permanent magnets 24b and 25b are examples of second and third magnets that are arranged with the central magnetic pole 26b interposed therebetween in the circumferential direction based on the rotary shaft 10 and have the magnetization directions in the circumferential direction toward the central magnetic pole 26b.

The magnetic pole 21c is obtained by horizontally inverting the magnetic pole 21a and the magnetic pole 21d is obtained by vertically inverting the magnetic pole 21b.

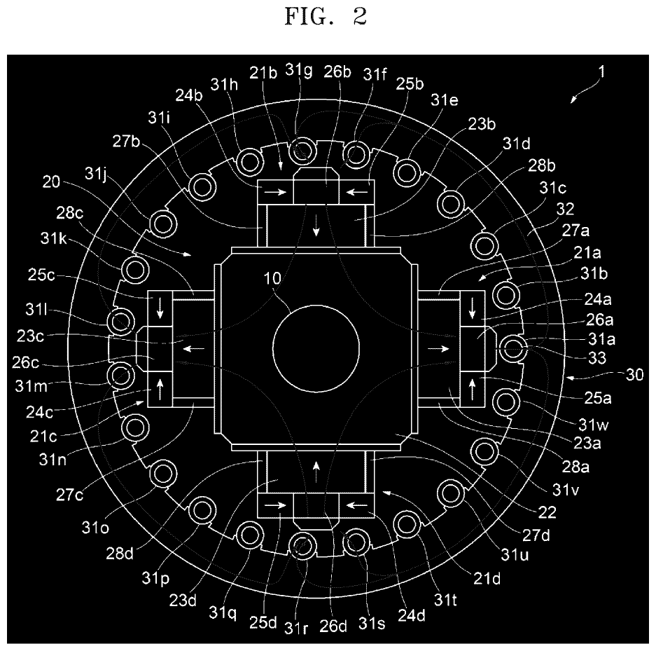

Here, for example, an example in which the rotor 20 rotates in the counter-clockwise direction and the magnetic pole 21a faces the magnetic material portion 31a as shown in FIG. 1 is assumed. FIG. 2 is a diagram showing an example of magnetic circuits formed when the magnetic pole 21a faces the magnetic material portion 31a in the rotating magnetic array device 1 of FIG. 1 according to an embodiment of the disclosure.

In this case, the line of magnetic force emitting from the N-pole of the central magnetic pole 26a passes through the magnetic material portion 31a and extends in the circumferential direction along the second yoke 32, and then, enters the S-pole of the central magnetic pole 26b after passing through the magnetic material portions 31f and 31g. The line of magnetic force emitting from the N-pole of the central magnetic pole 26a passes through the magnetic material portion 31a and extends in the circumferential direction along the second yoke 32, and then, enters the S-pole of the central magnetic pole 26d after passing through the magnetic material portions 31r and 31s. Also, the line of magnetic force emitting from the N-pole of the central magnetic pole 26b enters the S-pole of the central magnetic pole 26a after passing through the first yoke 22, and the line of magnetic force emitting from the N-pole of the central magnetic pole 26d enters the S-pole of the central magnetic pole 26a after passing through the first yoke 22. Therefore, a magnetic circuit including the central magnetic pole 26a—the second yoke 32—the central magnetic pole 26b—the first yoke 22 and a magnetic circuit including the central magnetic pole 26a—the second yoke 32—the central magnetic pole 26d—the first yoke 22 are formed.

Also, the line of magnetic force emitting from the N-pole of the central magnetic pole 26c passes through the magnetic material portion 311 and extends in the circumferential direction along the second yoke 32, and then, enters the S-pole of the central magnetic pole 26b after passing through the magnetic material portion 31g. The line of magnetic force emitting from the N-pole of the central magnetic pole 26c passes through the magnetic material portion 31m and extends in the circumferential direction along the second yoke 32, and then, enters the S-pole of the central magnetic pole 26d after passing through the magnetic material portion 31r. Also, the line of magnetic force emitting from the N-pole of the central magnetic pole 26b enters the S-pole of the central magnetic pole 26c after passing through the first yoke 22, and the line of magnetic force emitting from the N-pole of the central magnetic pole 26d enters the S-pole of the central magnetic pole 26c after passing through the first yoke 22. Therefore, a magnetic circuit including the central magnetic pole 26c—the second yoke 32—the central magnetic pole 26b—the first yoke 22 and a magnetic circuit including the central magnetic pole 26c—the second yoke 32—the central magnetic pole 26d—the first yoke 22 are formed.

Accordingly, the intensity of the magnetic field applied to the magnetic material portions 31a, 31b, 31f, 31g, 31h, 31l, 31m, 31q, 31r, 31s, and 31w approaches the maximum over time. On the contrary, the intensity of the magnetic field applied to the magnetic material portions 31c-31e, 31i-31k, 31n-31p, and 31t-31v approaches the minimum (closer to 0) over time. In this case, the magnetic material portion 31a is a magnetic material portion facing the center of one (21a) of the plurality of magnetic poles 21. Also, the magnetic material portions 31b, 31f, 31g, 31h, 31l, 31m, 31q, 31r, 31s, and 31w are the magnetic material portions each facing one of the plurality of magnetic poles 21, but not facing the center of the magnetic pole. Also, the magnetic material portions 31c-31e, 31i-31k, 31n-31p, and 31t-31v are the magnetic material portions each facing a point between two adjacent magnetic poles from among the plurality of magnetic poles 21.

Next, an example in which the rotor 20 rotates by an angle of (360/23)° in the counter-clockwise direction from the state shown in FIG. 1 and the magnetic pole 21a faces the magnetic material portion 31b is assumed. In this case, the intensity of the magnetic field applied to the magnetic material portions 31b, 31c, 31g, 31h, 31i, 31m, 31n, 31r, 31s, 31t, and 31a approaches the maximum over time. On the contrary, the intensity of the magnetic field applied to the magnetic material portions 31d-31f, 31j-31l, 31o-31q, and 31u-31w approaches the minimum (closer to 0) over time. In this case, the magnetic material portion 31b is a magnetic material portion facing the center of one (21a) of the plurality of magnetic poles 21. Also, the magnetic material portions 31c, 31g, 31h, 31i, 31m, 31n, 31r, 31s, 31t, and 31w are the magnetic material portions each facing one of the plurality of magnetic poles 21, but not facing the center of the magnetic pole. Also, the magnetic material portions 31d-31f, 31j-31l, 31o-31q, and 31u-31w are the magnetic material portions each facing a space between two adjacent magnetic poles from among the plurality of magnetic poles.

Hereinafter, an example in which the rotor 20 rotates from the state shown in FIG. 1 by an angle of (360/23×N)° and the magnetic pole 21a faces one of the magnetic material portions 31c-31w is assumed (N=2, 3, . . . , 22). In this case, likewise, the intensity of the magnetic field applied to the magnetic material portion 31 facing one of the magnetic poles 21a-21d approaches the maximum over time. On the other hand, the intensity of the magnetic field applied to the magnetic material portion 31 facing none of the magnetic poles 21a-21d approaches the minimum (closer to 0) over time.

Therefore, the intensity of the magnetic field applied to each of the magnetic material portions 31a-31w when the rotor 20 rotates about the rotary shaft 10 repeatedly increases and decreases. In addition, when the intensity of the magnetic field applied to each of the magnetic material portions 31a-31w repeatedly increases and decreases, the temperature of the MCM accommodated in the magnetocaloric unit 33 repeatedly rises and descends. When the temperature of the MCM descends, the MCM may generate cold energy.

In the drawings, the first permanent magnets 23a, 23b, 23c, and 23d, the second permanent magnets 24a, 24b, 24c, and 24d, the third permanent magnets 25a, 25b, 25c, and 25d, the central magnetic poles 26a, 26b, 26c, and 26d, the first non-magnetic members 27a, 27b, 27c, and 27d, and the second non-magnetic members 28a, 28b, 28c, and 28d are separately indicated, but when they are not discriminated, the first, second, and third permanent magnets are indicated by reference numerals 23, 24, and 25, the central magnetic poles are indicated by reference numeral 26, and the first and second non-magnetic members are indicated by reference numerals 27 and 28.

In FIG. 1, twenty-three magnetic material portions 31 are all heat generators, but some of the plurality of magnetic material portions 31 may not be the heat generators. Hereinafter, an example in which four of the twenty-three magnetic material portions 31 are the heat generators and remaining 19 magnetic material portions 31 are dummies is described below. Here, a dummy may denote a magnetic material portion 31 that includes a magnetic substance but does not generate the heat energy or cold energy even when the rotor 20 rotates. In this case, the four heat generators may be referred to as a plurality of heat generators generating the heat energy and cold energy according to the rotation of a magnetic field generator, that is, the rotor 20, and 19 dummies may be referred to as a plurality of non-heat generators that do not generate the heat energy and cold energy. Alternatively, the dummy may denote a magnetic material portion 31 that includes a magnetic substance and generates the heat energy or cold energy due to the rotation of the rotor 20, but does not supply the generated heat energy or cold energy to the outside. In this case, four heat generators may be referred to as a plurality of heat supply units that supply the heat energy and cold energy to the outside, but nineteen dummies may be referred to as a plurality of non-heat supply units that do not supply the heat energy and cold energy to the outside.

In the rotating magnetic array device 1 of FIG. 1, when a motor current supplied to a motor (not shown) rotating the rotary shaft 10 is increased, an input power increases and the COP degrades. Here, because the motor current is nearly in proportional to the torque, the torque may be minimized.

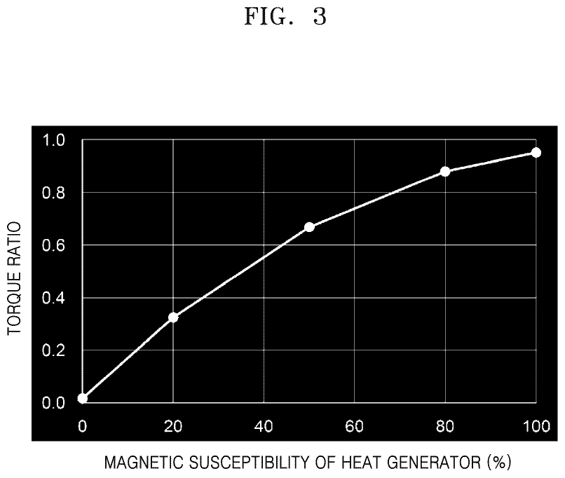

FIG. 3 is a graph showing an example of a relationship between a magnetization rate of a heat generator and a torque ratio when a dummy is not arranged. The graph of FIG. 3 shows a torque ratio with respect to a magnetic susceptibility of the heat generators when four heat generators are arranged and nineteen dummies are not arranged. Here, the magnetic susceptibility of the heat generator is represented in %, and the magnetic susceptibility of 0% denotes non-magnetism such as air and the magnetic susceptibility of 100% denotes ferro-magnetism such as SS400. Also, the torque ratio is a value of normalizing a torque by setting a maximum torque to 1. Referring to FIG. 3, when the magnetic susceptibility of the heat generator increases, the torque tends to increase.

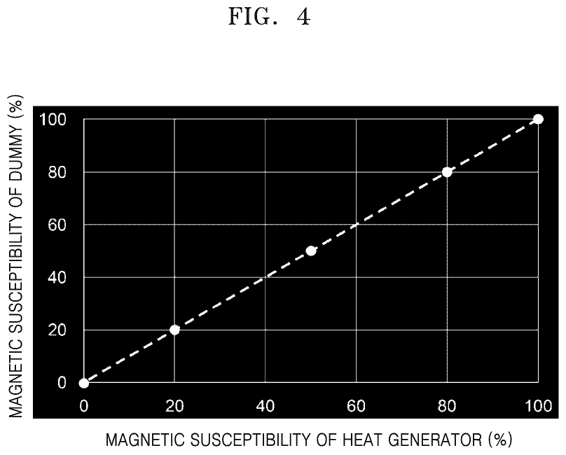

FIG. 4 is a graph showing an example of a relationship between a magnetization rate of the heat generator and a magnetization rate of a dummy where a torque is minimized. The magnetic susceptibility of the heat generator and the magnetization ratio of the dummy are represented in %, and the magnetic susceptibility of 0% denotes non-magnetism such as air and the magnetic susceptibility of 100% denotes ferro-magnetism such as SS400. Referring to FIG. 4, the torque degrades when the magnetic susceptibility of the heat generator and the magnetic susceptibility of the dummy are substantially equal to each other.

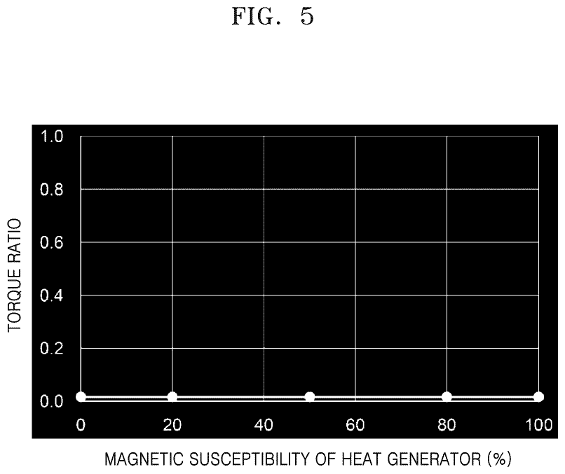

FIG. 5 is a graph showing an example of a relationship between the magnetic susceptibility of the heat generator and the torque ratio when the magnetic susceptibility of the dummy is changed. FIG. 5 shows a torque ratio when four heat generators and nineteen dummies are arranged and the relationship of FIG. 4 is applied. Referring to FIG. 5, the torque is greatly lowered as compared with the graph of FIG. 3. That is, the magnetic susceptibilities of the nineteen dummies may be nearly the same as the magnetic susceptibilities of the four heat generators.

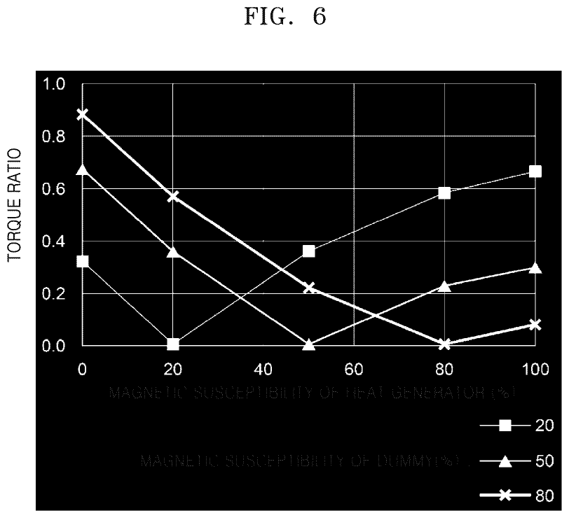

FIG. 6 is a graph showing an example of a relationship between the magnetic susceptibility of the heat generator and the magnetic susceptibility of the dummy with respect to a torque ratio. In FIG. 6, three lines respectively denote torque ratios according to the magnetic susceptibility of the heat generator when the magnetic susceptibilities of the dummy are respectively 20%, 50%, and 80%. Referring to FIG. 6, when the magnetic susceptibility of the heat generator increases, the magnetic susceptibility of the dummy causing minimum torque is also increased.

Therefore, the rotating magnetic array device 1 may be controlled to minimize the motor current by changing the magnetic susceptibilities of the dummies according to the estimated magnetic susceptibility of the heat generator and minimizing the torque.

In an embodiment, a structure in which a plurality of MCMs having different temperatures at which the MCE is the largest (Curie temperatures) are cascade-arranged in an order of Curie temperatures may be adopted as the heat generator. In this case, the plurality of MCMs may be each operated at its own Curie temperature. The MCM is ferro-magnetic at the Curie temperature or less and paramagnetic at the Curie temperature or greater. When the MCE is obtained by changing the intensity of the magnetic field applied to the heat generator, the MCM of the heat generator is in a state of changing between the ferro-magnetic substance and the paramagnetic substance around the Curie temperature. Therefore, because it is difficult to precisely identify the magnetic susceptibility of the heat generator, the rotating magnetic array device 1 may be controlled to minimize the motor current by changing the magnetic susceptibility of the dummy according to the estimated magnetic susceptibility of the heat generator and minimizing the torque.

The rotating magnetic array device 1 reduces torque pulsation by making the magnetic susceptibilities of the heat generators and the dummies included in, for example, twenty-three magnetic material portions 31, nearly the same as one another. In detail, the rotating magnetic array device 1 reduces the torque pulsation by changing the magnetic susceptibility of the dummy to be close to the magnetic susceptibility of the heat generator in correspondence with the changing of the MCM included in the heat generator into the ferro-magnetic substance and the paramagnetic substance around the Curie temperature.

A mechanism for changing the magnetic susceptibility of the dummy may include, for example, a magnetic susceptibility adjusting mechanism which changes the magnetic susceptibility of the dummy by inserting and withdrawing the ferromagnetic substance (e.g., iron) arranged in the dummy. The magnetic susceptibility adjusting mechanism (magnetic susceptibility adjusting portion) changes the magnetic susceptibilities of the plurality of non-heat generators according to the change of the magnetic susceptibilities of the plurality of heat generators. Also, the magnetic susceptibility adjusting mechanism (magnetic susceptibility adjusting portion) changes the magnetic susceptibility of each non-heat generator by inserting the magnetic substance of an amount corresponding to an amount of the magnetic substances in the plurality of heat generators into each of the plurality of non-heat generators.

When the magnetic susceptibility of the dummy is equal to the magnetic susceptibility of the heat generator, the torque pulsation reduces, and accordingly, the motor current may be reduced. On the contrary, when the magnetic susceptibility of the heat generator increases, the torque pulsation also increases, and the motor current needs to be increased. The magnetic susceptibility adjusting mechanism changes the magnetic susceptibility of the dummy so that the motor current is reduced. In this case, the magnetic susceptibility adjusting mechanism (magnetic susceptibility adjusting portion) changes the magnetic susceptibility of each of the plurality of non-heat generators so that the current flowing to the motor for rotating the magnetic field generator may be minimized.

When the rotor 20 rotates, a magnetic flux changes only on a portion where the magnetic pole 21 and the magnetic material portion 31 face each other and affects the torque. Thus, the magnetic susceptibility adjusting mechanism at least changes the magnetic susceptibility of the dummies in a range where the magnetic pole 21 approaches. In particular, because the temperature of the heat transfer medium coming into contact with the heat generator is nearly consistent during initial driving of a magnetic freezer system, the temperature of the heat transfer medium mostly exceeds the Curie temperature of the MCM included in the heat generator. Therefore, the magnetic susceptibility adjusting mechanism may reduce an input energy to the motor by changing the magnetic susceptibility of the dummy until the temperature of the heat transfer medium approaches the Curie temperature of the MCM. In this case, the magnetic susceptibility adjusting mechanism (magnetic susceptibility adjusting portion) changes the magnetic susceptibility of each non-heat generator when each of the plurality of non-heat generators faces one of the plurality of magnetic poles.

In the above embodiment, from among twenty-three magnetic material portions 31, four are the heat generators and nineteen are the dummies, but the number of the heat generators and the number of the dummies are not limited thereto. For example, eight magnetic material portions may be heat generators and fifteen magnetic material portions may be dummies.

Also, in the above embodiment, twenty-three magnetic material portions 31 are arranged, but the number of the magnetic material portions 31 is not limited thereto. For example, the number of the magnetic material portions 31 may be thirteen, sixteen, seventeen, twenty-four, etc.

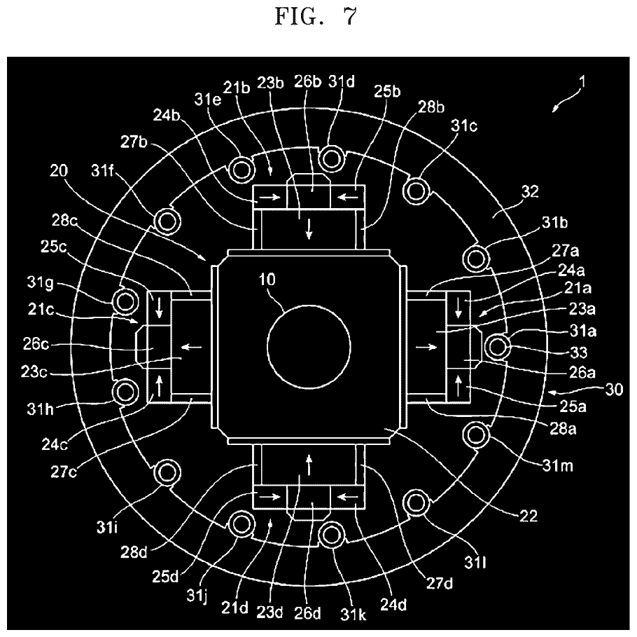

FIG. 7 is a diagram showing an example of the rotating magnetic array device 1 in which thirteen magnetic material portions 31 are arranged. The thirteen magnetic material portions 31 are separately represented by reference numerals 31a-31m. In this case, the magnetic material portion 31a is a magnetic material portion facing the center of one (21a) of the plurality of magnetic poles 21. Also, the magnetic material portions 31d and 31k are the magnetic material portions that face one of the plurality of magnetic poles 21, but do not face the center of the magnetic pole. Also, the magnetic material portions 31b, 31c, 31e-31j, 31l, and 31m are the magnetic material portions each facing a space between two adjacent magnetic poles from among the plurality of magnetic poles 21.

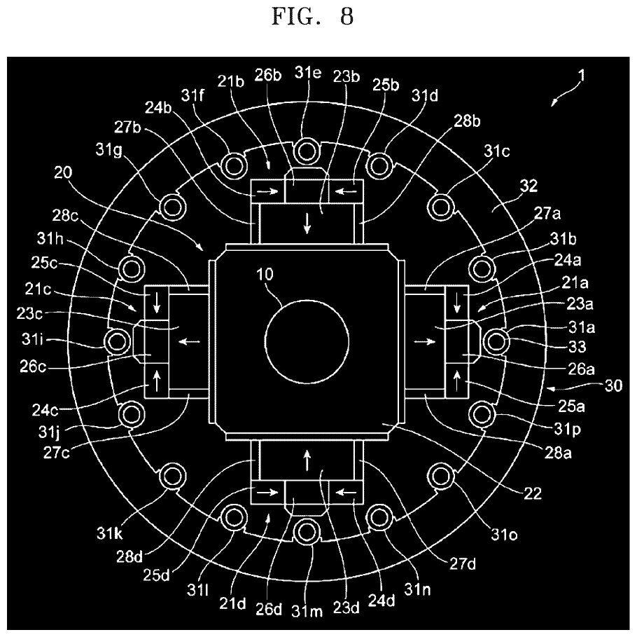

FIG. 8 is a diagram showing an example of the rotating magnetic array device 1 in which sixteen magnetic material portions 31 are arranged. The sixteen magnetic material portions 31 are separately represented by reference numerals 31a-31p. In this case, each of the magnetic material portions 31a, 31e, 31i, and 31m is a magnetic material portion facing the center of one 21a, 21b, 21c, and 21d of the plurality of magnetic poles 21, respectively. Also, the magnetic material portions 31b-31d, 31f-31h, 31j-31l, and 31n-31p are the magnetic material portions each facing a space between two adjacent magnetic poles from among the plurality of magnetic poles 21. In the embodiment shown in FIG. 8, there is no magnetic material portion that faces one of the plurality of magnetic poles 21 but does not face the center of the magnetic pole.

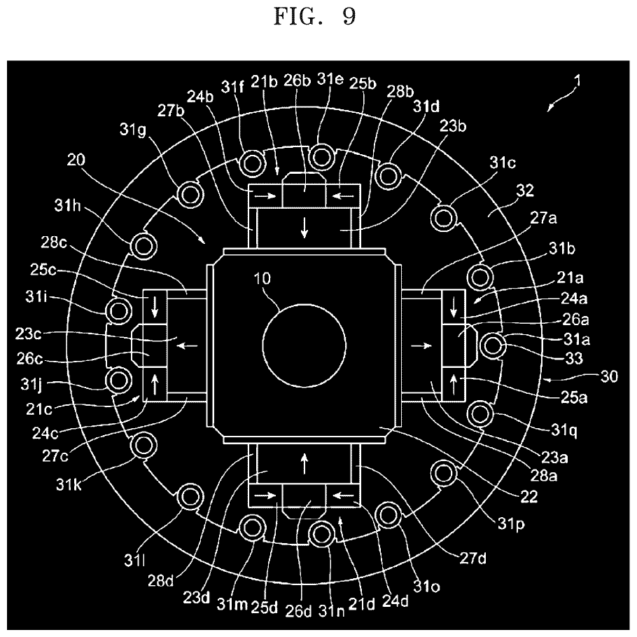

FIG. 9 is a diagram showing an example of the rotating magnetic array device 1 in which seventeen magnetic material portions 31 are arranged. The seventeen magnetic material portions 31 are separately represented by reference numerals 31a-31q. In this case, the magnetic material portion 31a is a magnetic material portion facing the center of one (21a) of the plurality of magnetic poles 21. Also, the magnetic material portions 31e and 31n are the magnetic material portions that face one of the plurality of magnetic poles 21, but do not face the center of the magnetic pole. Also, the magnetic material portions 31b-31d, 31f-31m, and 31o-31q are the magnetic material portions each facing a space between two adjacent magnetic poles from among the plurality of magnetic poles 21.

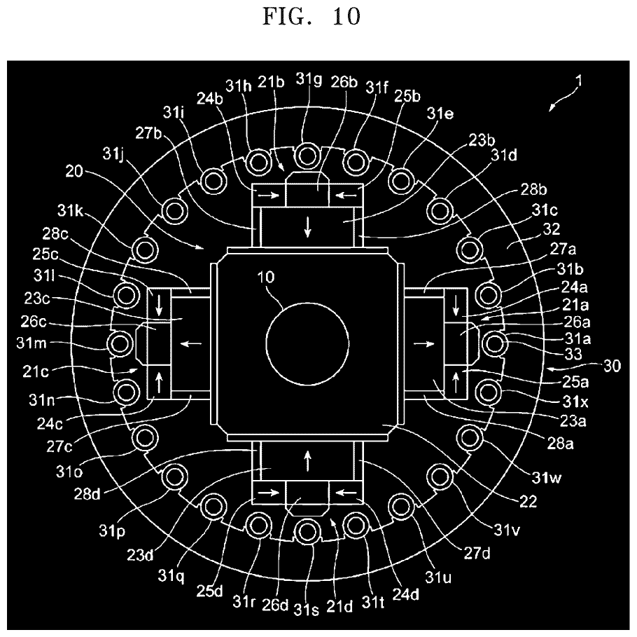

FIG. 10 is a diagram showing an example of the rotating magnetic array device 1 in which twenty-four magnetic material portions 31 are arranged. The twenty-four magnetic material portions 31 are separately represented by reference numerals 31a-31x. In this case, each of the magnetic material portions 31a, 31g, 31m, and 31s is a magnetic material portion facing the center of one 21a, 21b, 21c, and 21d of the plurality of magnetic poles 21, respectively. The magnetic material portions 31b and 31x do not face the center of the magnetic pole 21a, but according to simulation, the magnetic material portions 31b and 31x form a magnetic circuit along with the first yoke 22 and the second yoke 32. This is because the magnetic material portions 31b and 31x are arranged adjacent to the magnetic pole 21a. Therefore, the magnetic material portions 31b and 31x may be the magnetic material portions that face one of the plurality of magnetic poles 21, but do not face the center of the magnetic pole. Likewise, the magnetic material portions 31f, 31h, 31l, 31n, 31r, and 31t may be also the magnetic material portions each facing one of the plurality of magnetic poles 21, but not facing the center of the magnetic pole. Also, the magnetic material portions 31c-31e, 31i-31k, 31n-31p, and 31u-31w are the magnetic material portions each facing a space between two adjacent magnetic poles from among the plurality of magnetic poles 21.

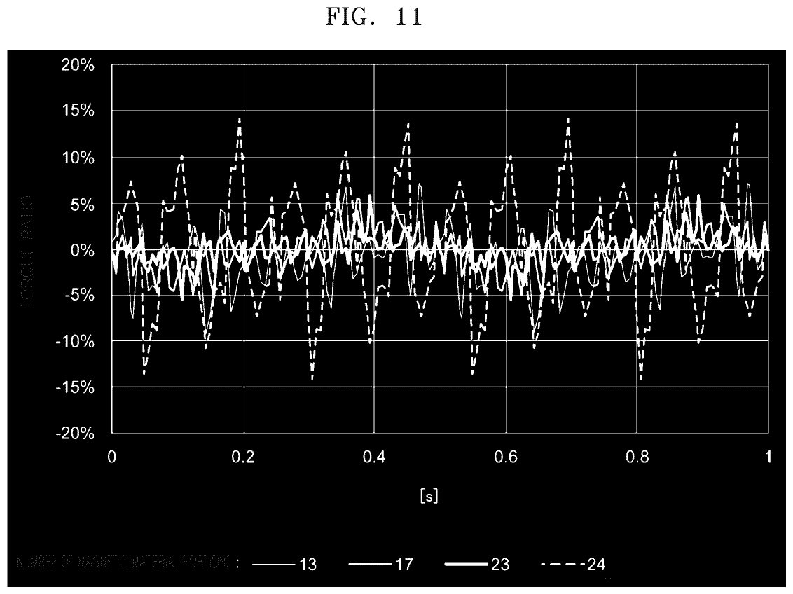

FIG. 11 is a graph showing a waveform of cogging torque that is the pulsation of the torque that is necessary for external driving, according to the number of the magnetic material portions 31. FIG. 11 shows waveforms of the cogging torques when thirteen, seventeen, and twenty-four magnetic material portions 31 are arranged as shown in FIGS. 7, 9, and 10, in addition to the example in which twenty-three magnetic material portions 31 are arranged as shown in FIG. 1. Also, the waveform of the cogging torque in an example in which the sixteen magnetic material portions 31 are arranged as shown in FIG. 8 is not shown because the torque ripple range is excessively large.

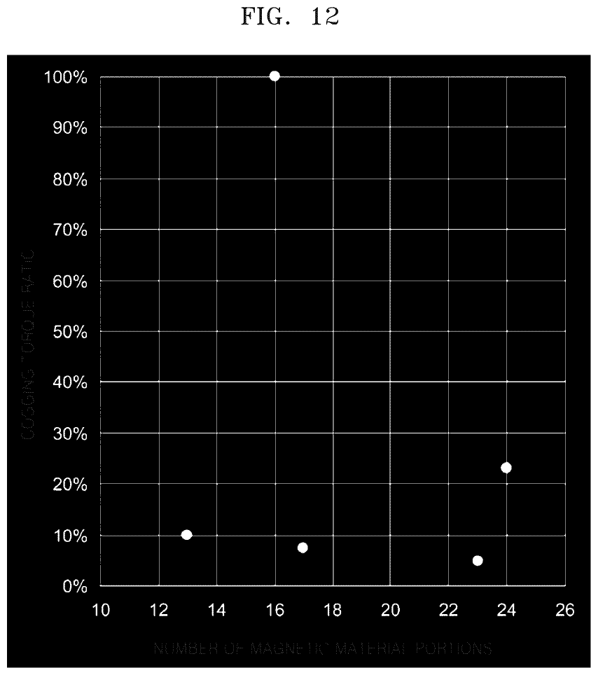

FIG. 12 is a diagram showing the relationship between the number of magnetic material portions 31 and the cogging torque ratio. The cogging torque ratio is a value of normalizing the cogging torque of the magnetic array device 1 shown in FIGS. 1, 7, 9, and 10 by setting the cogging torque of the rotating magnetic array device 1 shown in FIG. 8 to 100%. In each case, the cogging torque is an average value of absolute values of torque ripple ranges in the cogging torque waveforms shown in FIG. 11. In general, the cogging torque is defined as the torque ripple range, and the average value is 0. Here, in order to evaluate the influence of the input torque reduction, the cogging torque is evaluated as an average of the absolute values of the torque ripple ranges, not the torque ripple range itself.

Referring to FIG. 12, the cogging torque is greatly reduced when thirteen, seventeen, and twenty-three, e.g., the prime number, of the magnetic material portions 31 are arranged. Because the order of the cogging torque is determined by the least common multiple of the number of magnetic poles 21 and the number of magnetic material portions 31, the order of the cogging torque increases when the prime number of magnetic material portions 31 are arranged. In addition, when the order of the cogging torque increases, the change in the energy per one revolution is reduced and the torque pulsation is reduced. Also, the number of magnetic material portions 31 may be the prime number less than thirteen, e.g., five or eleven. As described above, when the prime number of magnetic material portions 31 are arranged, as shown in FIGS. 1, 7, and 9, the arrangement relationship between the plurality of magnetic material portions 31 and the plurality of magnetic poles 21 are not in rotational symmetry. Rotational symmetry denotes a case in which the arrangements of the plurality of magnetic material portions 31 before and after rotation overlap each other, when one of the plurality of magnetic material portions 31 is rotated from a position facing one of the plurality of magnetic poles 21 to a position facing another one of the plurality of magnetic pole 21.

Also, referring to FIG. 12, the cogging torque when twenty-four magnetic material portions 31 are arranged is also somewhat suppressed, although not as much as in the case in which the prime number of magnetic material portions 31 are arranged. As described above with reference to FIG. 10, when twenty-four magnetic material portions 31 are arranged, there are the magnetic material portion 31 facing the center of one of the magnetic poles 21, the magnetic material portion 31 facing one of the magnetic poles 21 but not facing the center of the magnetic pole 21, and the magnetic material portion 31 facing the space between two of the magnetic poles 21.

In addition, referring to FIG. 12, the cogging torque when sixteen magnetic material portions 31 are arranged is excessively greater than the cogging torque when thirteen, seventeen, twenty-three, and twenty-four magnetic material portions 31 are arranged. Therefore, an arrangement of sixteen magnetic material portions 31 may not be adopted in order to reduce the cogging torque. Also, when sixteen magnetic material portions 31 are arranged, it may be considered that there are the magnetic material portion 31 facing the center of one of the magnetic poles 21 and the magnetic material portion 31 facing the space between two magnetic poles 21. However, it may not be said that the magnetic material portion 31 facing one of the magnetic poles 21 but not facing the center of the magnetic pole 21 exists simultaneously.

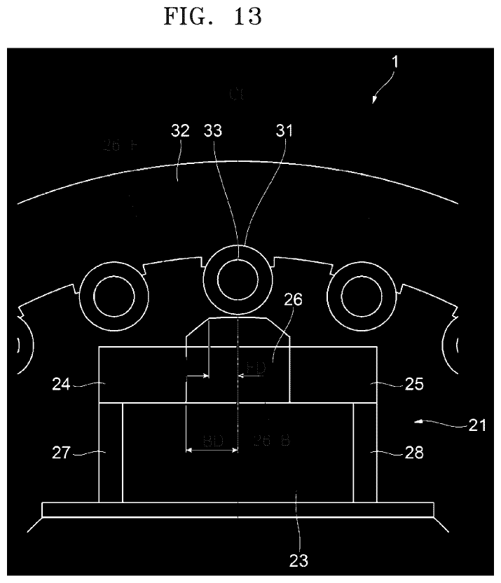

Hereinafter, a relationship between dimensions of two end portions of the central magnetic pole 26 in the radial direction and the torque ratio is described below. FIG. 13 is a diagram showing a vicinity of the central magnetic pole 26 in detail. Referring to FIG. 13, a front dimension and a back dimension of the central magnetic pole 26 are described below. Between two end portions of the central magnetic pole 26 in the radial direction, a width of an outer end portion 26-F, that is, an end portion at the side of the magnetic material portion 31, is referred to as the front dimension, and a width of an inner end portion 26-B, that is, an end portion at the side of magnet arrangements (e.g., permanent magnet 23), is referred to as a back dimension. Also, the cross-sectional shape of the central magnetic pole 26 is assumed to be a line-symmetrical with respect to a center line CL in the radial direction. With respect to the front dimension, a dimension of a part of the outer end portion 26-F at one side of the center line CL is referred to as ‘½ front dimension (FD)’, and with respect to the back dimension, a dimension of a part of the inner end portion 26-B at one side of the center line CL is referred to as ‘½ back dimension (BD)’. However, the cross-section of the central magnetic pole 26 may not be line-symmetrical with respect to the center line CL.

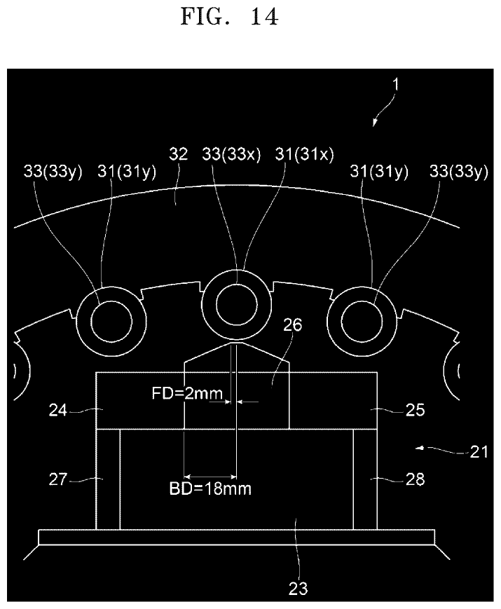

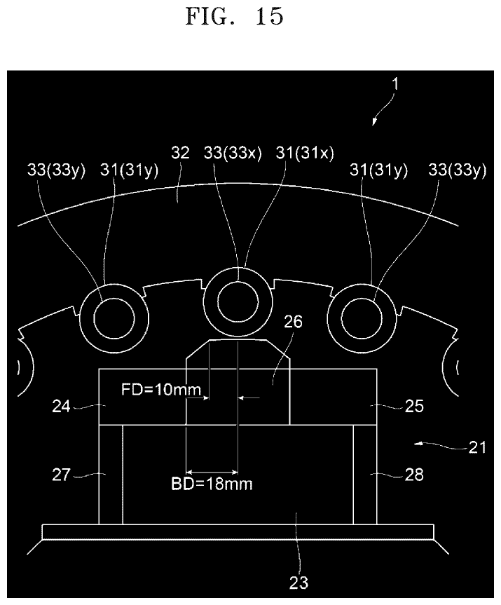

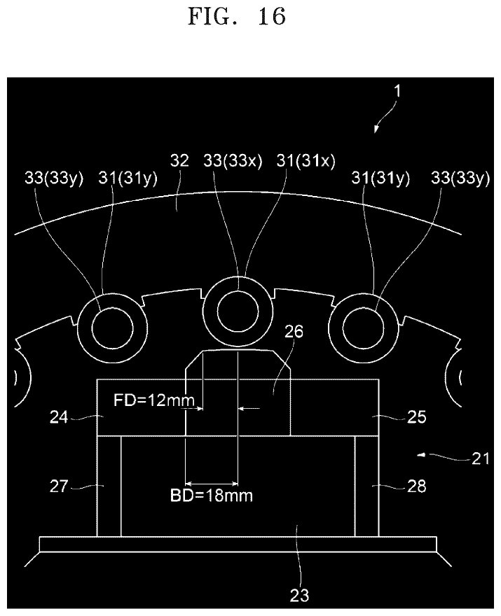

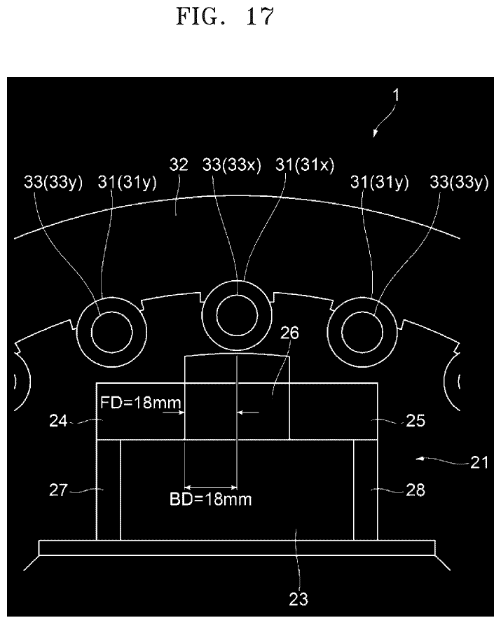

First, for example, it is assumed that ½ BD of the central magnetic pole 26 is 18 mm and a radius of the magnetocaloric unit 33 is 7 mm. FIG. 14 is a diagram showing a part of the rotating magnetic array device 1 when the ½ FD of the central magnetic pole 26 is 2 mm. FIG. 15 is a diagram showing a part of the rotating magnetic array device 1 when the ½ FD of the central magnetic pole 26 is 10 mm. FIG. 16 is a diagram showing a part of the rotating magnetic array device 1 when the ½ FD of the central magnetic pole 26 is 12 mm. FIG. 17 is a diagram showing a part of the rotating magnetic array device 1 when the ½ FD of the central magnetic pole 26 is 18 mm. In FIG. 17, because the ½ FD and the ½ BD of the central magnetic pole 26 are equal to each other, the front end portion of the central magnetic pole 26 is entirely arc shape.

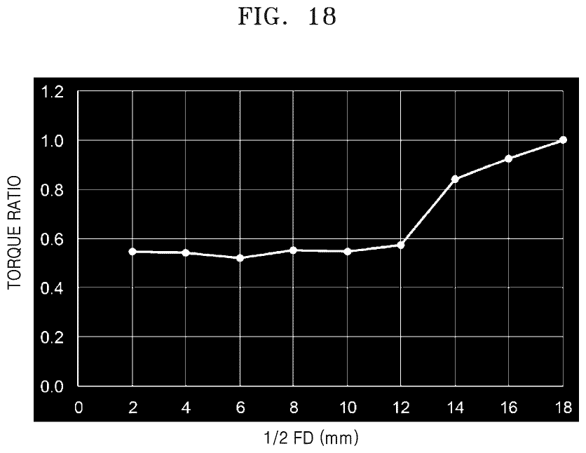

FIG. 18 is a graph showing a relationship between the ½ FD of the central magnetic pole 26 and the torque ratio. The torque ratio is a value of normalizing a torque by setting a maximum torque to 1 at the torque pulsation. The torque pulsation is a torque pulsation of the motor rotating the magnetic pole 21. Referring to FIG. 18, as shown in FIGS. 14 to 16, when the ½ FD of the central magnetic pole 26 is less than 12 mm, the torque pulsation is lowered. That is, when the ½ FD of the central magnetic pole 26 is less than the ½ BD of the central magnetic pole 26, the torque pulsation is lowered. Therefore, the central magnetic pole 26 may be a magnetic pole of which the front dimension is less than the back dimension. The central magnetic pole 26 is an example of a magnetic pole in which the width of the outer end portion 26-F, that is, the end portion at the side of the magnetic material portion 31, is less than the width of the inner end portion 26-B, that is, the end portion at the side of the magnet arrangement.

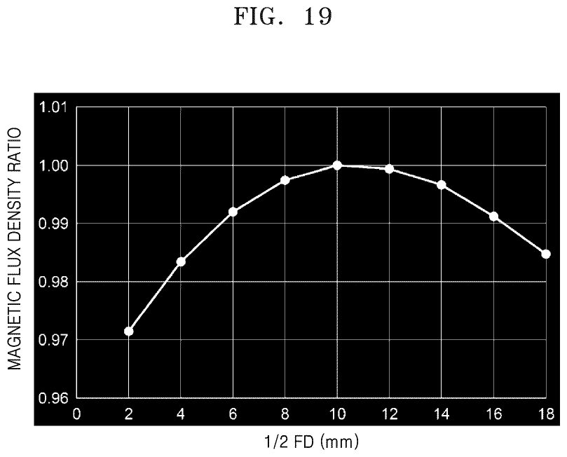

FIG. 19 is a graph showing a relationship between the ½ FD of the central magnetic pole 26 and a magnetic flux density ratio. Here, the magnetic flux density ratio is a value normalizing the magnetic flux by setting a maximum magnetic flux to 1. The magnetic flux density is the magnetic flux density at a center of an air gap between the magnetic pole 21 and the magnetic material portion 31. Referring to FIG. 19, when the ½ FD of the central magnetic pole 26 is too short (that is, less than the radius of the magnetocaloric unit 33) as shown in FIG. 14, the magnetic flux density is reduced, and when the ½ FD of the central magnetic pole 26 is 10 mm to 12 mm (that is, the ½ FD of the central magnetic pole 26 is longer than the radius of the magnetocaloric unit 33) as shown in FIGS. 15 and 16, the magnetic flux density increases. This is because a sufficient magnetic flux is not granted to magnetocaloric unit 33, provided that the ½ FD of the central magnetic pole 26 is too short. Therefore, the central magnetic pole 26 may be a magnetic pole of which the front dimension is longer than the radius of the magnetocaloric unit 33. Alternatively, when the magnetic working unit 33 is formed in a rectangular shape, the central magnetic pole 26 may be a magnetic pole of which the front dimension is longer than a length of the facing side of the magnetocaloric unit 33. The central magnetic pole 26 is an example of the magnetic pole in which the width of the outer end portion 26-F, that is, the width of the end portion at the side of the magnetic material portion 31, is longer than the width of the magnetocaloric unit 33.

Also, when the central magnetic pole 26 faces one (31x) of the plurality of magnetic material portions 31 in the radial direction, a distance between the central magnetic pole 26 and the magnetocaloric unit 33y of another magnetic material portion 31y adjacent to the magnetic material portion 31x facing the central magnetic pole 26 is greater than a distance between the central magnetic pole 26 and the magnetocaloric unit 33x of the facing magnetic material portion 31x. When the central magnetic pole 26 faces the magnetic material portion 31x in the radial direction, the surface of the central magnetic pole 26 may be closer to the magnetocaloric unit 33x of the magnetic material portion 31x (see FIGS. 14 to 17) than the magnetocaloric unit 33y of another magnetic material portion 31y adjacent to the magnetic material portion 31x (see FIGS. 14 to 17). In other words, the distance between the surface of the central magnetic pole 26 and the magnetocaloric unit 33y may be longer than the distance between the surface of the central magnetic pole 26 and the magnetocaloric unit 33x. Here, the surface of the central magnetic pole 26 is an outer circumferential surface of the central magnetic pole 26. In other words, the surfaces of the central magnetic pole 26 include the circumferential surface of the outer end portion 26-F, facing the magnetic material portion 31x, two surfaces in the axial direction on left and right sides of the circumferential surface, and two slant surfaces connecting the two surfaces to the circumferential surface in FIGS. 14 to 16, and include the circumferential surface of the outer end portion 26-F, facing the magnetic material portion 31x, and two surfaces in the axial direction at the left and right sides of the circumferential surface in FIG. 17. Also, the distance to the magnetocaloric unit 33 may be measured based on the center of the magnetocaloric unit 33. The central magnetic pole 26 is an example of the magnetic pole of which a distance between the surface thereof and the magnetocaloric unit 33y of the magnetic material portion 31y adjacent to the magnetic material portion 31x facing the central magnetic pole 26 is longer than a distance between the surface thereof and the magnetocaloric unit 33x of the magnetic material portion 31x facing the central magnetic pole 26. For example, when the ½ BD is increased, the magnetocaloric unit 33y may be closer to the surface of the central magnetic pole 26 than the magnetocaloric unit 33x. In this case, the magnetic flux is not concentrated on the magnetocaloric unit 33x, but flows to the magnetocaloric unit 33y, and thus, a strong magnetic flux may not be applied to the magnetocaloric unit 33x.

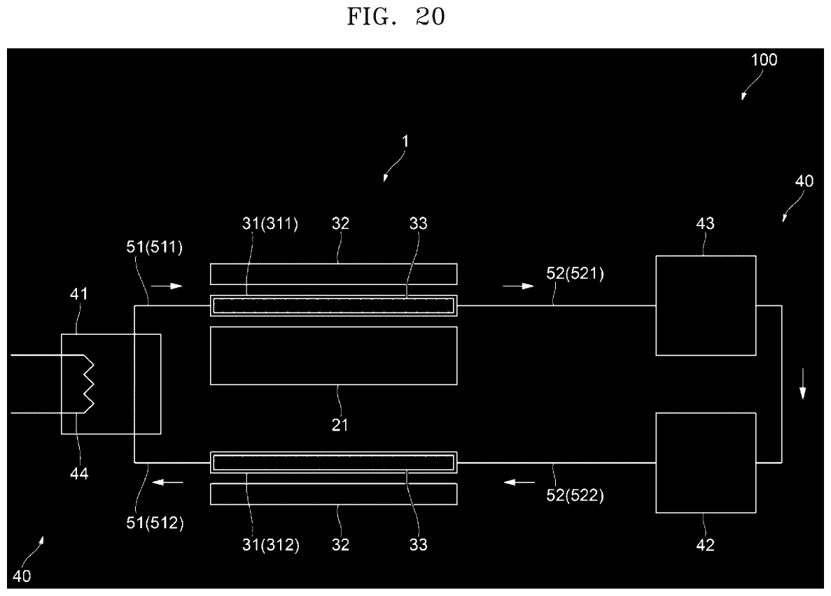

FIG. 20 is a schematic block diagram of a magnetic freezer system (or magnetic cooling apparatus) 100 according to an embodiment of the disclosure. Referring to FIG. 20, the magnetic freezer system 100 may include the rotating magnetic array device 1 and a cold energy extracting device 40.

The rotating magnetic array device 1 may include the plurality of magnetic poles 21, the plurality of magnetic material portions 31, and the second yoke 32. The rotating magnetic array device 1 is described above with reference to FIGS. 1 to 19. The plurality of magnetic poles 21 are the plurality of magnetic poles 21a-21d in the rotating magnetic array device 1 shown in FIGS. 1, 7, 9, and 10. FIG. 20 shows one magnetic pole 21, and the magnetic pole 21 is one of the plurality of magnetic poles 21a-21d in the rotating magnetic array device 1 according to the embodiments of FIGS. 1, 7, 9, and 10.

A magnetic material portion 311 is the magnetic material portion 31 that generates heat energy as approaching the magnetic pole 21 from among the plurality of magnetic material portions 31. A magnetic material portion 312 is the magnetic material portion 31 that generates cold energy as being away from the magnetic pole 21 from among the plurality of magnetic material portions 31. Here, the plurality of magnetic material portions 31 are the plurality of magnetic material portions 31a-31w in the rotating magnetic array device 1 according to the embodiment of FIG. 1, the magnetic material portions 31a-31m in the rotating magnetic array device 1 according to the embodiment of FIG. 7, the magnetic material portions 31a-31q in the rotating magnetic array device 1 according to the embodiment of FIG. 9, and the magnetic material portions 31a-31x in the rotating magnetic array device 1 according to the embodiment of FIG. 10. In this case, the magnetic material portion 311 is an example of the heat generator generating the heat energy according to the rotation of the magnetic field generator, that is, the rotor 20, and the magnetic material portion 312 is an example of the heat generator generating the cold energy according to the rotation of the magnetic field generator, that is, the rotor 20.

The magnetic material portion 311 may be the magnetic material portion 31 that generates the heat energy when approaching the magnetic pole 21 and supplies the heat energy to the outside. The magnetic material portion 312 may be the magnetic material portion 31 that generates the cold energy when being away from the magnetic pole 21 and supplies the cold energy to the outside. In this case, the magnetic material portion 311 is an example of a heat supply portion supplying the heat energy to the outside, and the magnetic material portion 312 is an example of the heat supply portion supplying the cold energy to the outside. On the contrary, even when the magnetic material portion 31 generates the heat energy while approaching the magnetic pole 21, the magnetic material portion 31 is not the magnetic material portion 311 unless the heat energy is supplied to the outside. Also, even when the magnetic material portion 31 generates the cold energy while being away from the magnetic pole 21, the magnetic material portion 31 is not the magnetic material portion 312 unless the cold energy is supplied to the outside. That is, the magnetic material portion 31 that is an example of the non-heat supply portion that does not supply the heat energy to the outside is not the magnetic material portion 311, and the magnetic material portion 31 that is an example of the non-heat supply portion that does not supply the cold energy to the outside is not the magnetic material portion 312.

The cold energy extracting device 40 includes a cooler 41, a pump 42, and an exhaust heat exchanger 43. The cold energy extracting device 40 circulates a medium (heat transfer medium) between the magnetic material portions 311 and 312 so as to extract the cold energy generated by the magnetocaloric unit 33 included in the magnetic material portion 312 and cool down a cooling target 44. The cooling target 44 receives the cold energy generated by the magnetocaloric unit 33 included in the magnetic material portion 312 through the heat exchange with the heat transfer medium in the cooler 41 and is cooled down. Here, the heat transfer medium may be, for example, water. The cold energy extracting device 40 is an example of the cold energy extracting device that extracts the cold energy when one of the plurality of heat generators generates the cold energy. Also, the cold energy extracting device does not extract the cold energy even when the plurality of non-heat supply portions generate the cold energy.

In order to circulate the heat transfer medium between the cold energy extracting device 40 and the magnetic material portions 311 and 312, the magnetic material portions 311 and 312 are connected to the cooler 41 via a low temperature piping network including a low temperature piping 51, and connected to the exhaust heat exchanger 43 via a high temperature piping network including a high temperature piping 52. In detail, the magnetic material portion 311 is connected to the cooler 41 via a low temperature piping 511 and connected to the exhaust heat exchanger 43 via a high temperature piping 521. The magnetic material portion 312 is connected to the cooler 41 via a low temperature piping 512 and connected to the exhaust heat exchanger 43 via a high temperature piping 522.

In FIG. 20, the intensity of the magnetic field applied to the magnetic material portion 311 is the maximum over time, and the temperature of the MCM included in the magnetocaloric unit 33 accommodated in the magnetic material portion 311 is the highest over time. On the contrary, the intensity of the magnetic field applied to the magnetic material portion 312 is the minimum (nearly 0) over time, and the temperature of the MCM included in the magnetocaloric unit 33 accommodated in the magnetic material portion 312 is the lowest over time.

In this case, the heat transfer medium exchanging heat with the outside in the exhaust heat exchanger 43 is sent to the magnetic material portion 312 by the pump 42 via the high temperature piping 522, and is cooled down by the magnetocaloric unit 33 of which the temperature is descended in the magnetic material portion 312. In addition, the heat transfer medium cooled down in the magnetic material portion 312 is sent to the cooler 41 via the low temperature piping 512, and cools down the cooling target 44 in the cooler 41. The medium cooling down the cooling target 44 in the cooler 41 is sent to the magnetic material portion 311 through the low temperature piping 511, and is heated by the magnetocaloric unit 33 of which the temperature is ascended in the magnetic material portion 311. Then, the heat transfer medium heated in the magnetic material portion 311 is sent to the exhaust heat exchanger 43 through the high temperature piping 521 and exchanges heat in the exhaust heat exchanger 43.

The magnetic freezer (or cooling) system 100 may be applied to various apparatuses for cooling and/or freezing, such as an air conditioner, a refrigerator, a kimchi refrigerator, a wine cooler, etc.

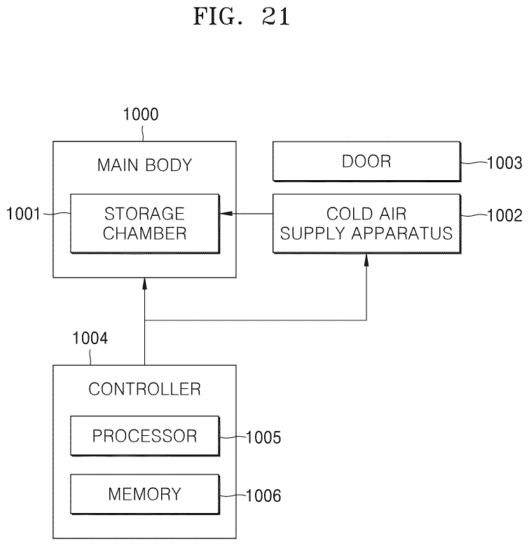

FIG. 21 is a schematic block diagram of a refrigerator according to an embodiment of the disclosure. Referring to FIG. 21, the refrigerator may include a main body 1000 provided with at least one storage chamber 1001, and a cold air supply apparatus 1002 supplying the cold air (cold energy) to the storage chamber 1001. The cold air supply apparatus 1002 may be implemented by the magnetic freezer system 100 shown in FIG. 20. In other words, the cold air supply apparatus 1002 may include the rotating magnetic array device 1 and the cold energy extracting device 40 for extracting the cold energy generated by the rotating magnetic array device 1. In this case, the cooling target 44 may be the air in the storage chamber 1001. For example, the air in the storage chamber 1001 is supplied to the cooler 41 and is cooled down by the cold energy that is generated by the magnetocaloric unit 33 included in the magnetic material portion 312 through the heat exchange with the heat transfer medium in the cooler 41. The cooled air may be supplied to the storage chamber 1001 again.

For example, the main body 1000 may include an inner case, an outer case arranged outside the inner case, and an insulating material provided between the inner case and the outer case. “Inner case” may include at least one of a case, a plate, a panel, or a liner forming a storage chamber. The inner case may be formed as one body or may be formed by assembling a plurality of plates. “Outer case” may form the exterior of the main body 1000 and may be coupled to the outer side of the inner case so that the insulating material can be disposed between the inner case and the outer case.

“Insulating material” may insulate interior and exterior of the storage chamber so that a temperature in the storage chamber may be maintained at a set appropriate temperature without being affected by an external environment of the storage chamber. According to an embodiment of the disclosure, the insulating material may include a foam insulating material. Urethane foam in which polyurethane and foaming agent are mixed is injected and foamed between the inner case and the outer case, and thus, the foam insulating material may be formed.

According to an embodiment of the disclosure, the insulating material may include a vacuum insulating material in addition to the foam insulating material, or the insulating material may be only formed of the vacuum insulating material, instead of the foam insulating material. The vacuum insulating material may include a core material, and an outer cover material accommodating the core material and sealing the inside to vacuum state or a pressure close to the vacuum. However, the insulating material is not limited to the foam insulating material or vacuum insulating material, but may include various materials that may be used for insulation.

The storage chamber 1001 may include a space defined by the inner case. The storage chamber 1001 may further include the inner case defining a space corresponding to the storage chamber 1001. The storage chamber 1001 may store various items such as food, medicine, cosmetics, etc., and the storage chamber 1001 may be formed to have at least one open side in order to withdraw or accommodate items.

The refrigerator may include one or more storage chambers 1001. When two or more storage chambers 1001 are formed in the refrigerator, the storage chambers 1001 may have different purposes and may be maintained at different temperatures from each other. To this end, the storage chambers 1001 may be partitioned by partition walls including the insulating material.

The storage chamber 1001 may be provided to be maintained at an appropriate temperature range according to the purpose thereof, and may include a “refrigerating chamber”, a “freezing chamber”, or a “temperature changeable chamber” which are distinguished according to the use and/or the temperature range. The refrigerating chamber may be maintained at a temperature that is appropriate for refrigerating items, and the freezing chamber may be maintained at a temperature appropriate for freezing the items. “Refrigerating” may denote cooling-down the items within a non-freezing range, for example, the refrigerating chamber may be maintained within a range of 0° Celsius to 7° Celsius. “Freezing” may denote freezing the items or cooling down the items to be stored in a frozen state, for example, the freezing chamber may be maintained within a range of −20° Celsius to −1° Celsius. The temperature changeable chamber may be used as one of the refrigerating chamber or the freezing chamber according to a selection of a user or regardless of the selection of the user.

The storage chamber 1001 may be referred to by various names such as “vegetable chamber”, “fresh chamber”, “cooling chamber”, “ice-making chamber”, etc. in addition to the “refrigerating chamber”, “freezing chamber”, and “temperature changeable chamber”. In addition, terms such as “refrigerating chamber”, “freezing chamber”, and “temperature changeable chamber” used herein should be appreciated to encompass the storage chamber 1001 having corresponding purpose and temperature range.

According to an embodiment of the disclosure, the refrigerator may include at least one door 1003 configured to open or close open one side of the storage chamber 1001. The door 1003 may be provided to open/close each of the one or more storage chambers 1001 or one door 1003 may be provided to open/close the plurality of storage chambers 1001. The door 1003 may be installed on the front surface of the main body 1000 to be rotatable or slidable.

The door 1003 may be configured to seal the storage chamber when the door 1003 is closed. The door 1003 may include the insulating material, like the main body, in order to insulate the storage chamber when the door 1003 is closed.

According to an embodiment, the door 1003 may include a door exterior forming a front surface of the door 1003, a door inner plate forming a rear surface of the door 1003 and facing the storage chamber 1001, an upper cap, a lower cap, and a door insulating material provided therein.

A gasket may be provided on a boundary of the door inner plate so as to seal the storage chamber 1001 by coming into close contact with the front surface of the main body 1000 when the door 1003 is closed. The inner door plate may include a dyke protruding backward so that door baskets for storing items may be attached.

According to an embodiment of the disclosure, the door 1003 may include a door body, and a front panel which is separately coupled to the front side of the door body and forms the front surface of the door 1003. The door body may include the outer door plate forming the front surface of the door body, the inner door plate forming the rear surface of the door body and facing the storage chamber, the upper cap, the lower cap, and the door insulator provided inside the upper cap and the lower cap.

The refrigerator may be classified in a French door type, a side-by-side type, a bottom mounted freezer (BMF), a top mounted freezer (TMF), or a one-door refrigerator according to the arrangement of the door 1003 and the storage chamber 1001.

According to an embodiment of the disclosure, the refrigerator may include a cold air supply apparatus 1002 provided to supply cold air to the storage chamber 1001. The cold air supply apparatus 1002 may include machines, mechanisms, electronic devices, and/or systems combining the same, capable of generating cold air and guiding the cold air to cool down the storage chamber 1001. As described above, the cold air supply apparatus 1002 may be implemented by the magnetic freezer system 100 shown in FIG. 20.

According to an embodiment of the disclosure, the refrigerator may include a machinery chamber provided so that at least some components of the cold air supply apparatus 1002 may be arranged. “Machinery chamber” may be provided to be partitioned and insulated from the storage chamber 1001 in order to prevent the heat generated from the components arranged in the machinery chamber from transferring to the storage chamber 1001. The interior of the machinery chamber may be formed to communicate with the outside of the main body 1000 so as to dissipate heat from the components arranged in the machinery chamber.

According to an embodiment of the disclosure, the refrigerator may include a dispenser provided in the door for providing water and/or ice. The dispenser may be provided in the door so that a user may access without opening the door.

According to an embodiment of the disclosure, the refrigerator may include an ice-making apparatus provided to generate ice. The ice-making apparatus may include an ice-making tray storing water, an ice-separating device for separating ice from the ice-making tray, and an ice bucket storing ice generated by the ice-making tray.

According to an embodiment of the disclosure, the refrigerator may include a controller 1004 for controlling the refrigerator.

The controller 1004 may include memory 1006 for storing or recording programs and/or data for controlling the refrigerator, and a processor 1005 that outputs a control signal for controlling the cold air supply apparatus, etc. according to the programs and/or data stored in the memory 1006.

The memory 1006 may store or record various information, data, instructions, programs, etc. required to operate the refrigerator. The memory 1006 may record temporary data generated while generating a control signal for controlling components included in the refrigerator. The memory 1006 may include at least one of a volatile memory or a non-volatile memory, or a combination thereof.

The processor 1005 controls overall operations of the refrigerator. The processor 1005 may control the components of the refrigerator by executing the programs stored in the memory 1006. The processor 1005 may include an additional neural processing unit (NPU) performing operations of an artificial intelligence (AI) model. Also, the processor 1005 may include a central processor unit (CPU), a graphics processor unit (GPU), etc. The processor 1005 may generate a control signal for controlling operations of the cold air supply apparatus 1002. For example, the processor 1005 receives temperature information of the storage chamber 1001 from a temperature sensor and generate a cooling control signal for controlling operations of the cold air supply apparatus 1002 based on the temperature information of the storage chamber 1001.

Also, the processor 1005 may process user inputs from a user interface according to the programs and/or data recorded/stored in the memory 1006 and control the operations of the user interface. The user interface may be provided via an input interface and an output interface. The processor 1005 may receive the user input from the user interface. Also, the processor 1005 may transfer a display control signal and image data for displaying images on the user interface to the user interface, in response to the user input.

The processor 1005 and the memory 1006 may be integrally or separately provided. The processor 1005 may include at least one processor. For example, the processor 1005 may include a main processor and at least one sub-processor. The memory 1006 may include one or more memories.

According to an embodiment of the disclosure, the refrigerator may include the processor 1005 and the memory 1006 controlling all components included in the refrigerator, and may include a plurality of processor and a plurality of memories individually controlling components of the refrigerator. For example, the refrigerator may include a processor and a memory controlling operations of the cold air supply apparatus 1002 according to an output from the temperature sensor. Also, the refrigerator may separately include a processor and a memory controlling operations of the user interface according to the user input.

A communication module may communicate with an external device such as a server, a mobile device, another home appliance, etc. through a peripheral access point (AP). The AP may connect a local area network (LAN) to which the refrigerator or user device is connected to a wide area network (WAN) to which the server is connected. The refrigerator or the user device may be connected to the server through the wide area network (WAN).

The input interface may include a key, a touch screen, a microphone, etc. The input interface may receive the user input and transfer the user input to the processor.

The output interface may include a display, a speaker, etc. The output interface may output various notifications, messages, information, etc. generated in the processor.

The refrigerator according to an aspect of the disclosure includes a main body provided with at least one storage chamber, and a cold air supply apparatus provided with a rotating magnetic array device and a cold air extracting device for extracting the cold energy generated in the rotating magnetic array device, and supplying the cold energy to the storage chamber. The rotating magnetic array device includes a magnetic field generator including a plurality of magnetic poles generating a magnetic field, and being rotatable about a rotary shaft, and a plurality of magnetic material portions including a plurality of heat generators generating heat energy and cold energy according to rotation of the magnetic field generator. The plurality of magnetic material portions are arranged on a circumference based on the rotary shaft, so as to simultaneously include a first magnetic material portion facing a center of one of the plurality of magnetic poles, a second magnetic material portion facing one of the plurality of magnetic poles and not facing a center of the magnetic pole, and a third magnetic material portion facing a space between two of the plurality of magnetic poles.

According to an embodiment, an arrangement relationship between the plurality of magnetic material portions and the plurality of magnetic poles may not be in rotational symmetry.

According to an embodiment, the number of the plurality of magnetic poles may be a prime number.

According to an embodiment, the plurality of magnetic material portions may include at least one dummy that does not generate heat energy or cold energy.

According to an embodiment, a magnetic susceptibility of the at least one dummy may be nearly equal to magnetic susceptibilities of the plurality of heat generators.

According to an embodiment, the rotating magnetic array device may include a magnetic susceptibility adjusting portion that changes a magnetic susceptibility of the at least one dummy according to a change in the magnetic susceptibility of the plurality of heat generators.

According to an embodiment, the magnetic susceptibility adjusting portion changes a magnetic susceptibility of the at least one dummy so that a motor current for rotating the magnetic field generator is minimum.

According to an embodiment, the magnetic susceptibility adjusting portion may change a magnetic susceptibility of a dummy facing one of the plurality of magnetic poles, from among the at least one dummy, when the magnetic field generator is rotated.

According to an embodiment, the magnetic susceptibility adjusting portion may change the magnetic susceptibility of the at least one dummy by inserting a magnetic substance of an amount corresponding to an amount of magnetic substance in the plurality of heat generators into each of the at least one dummy.

According to an embodiment, each of the plurality of magnetic poles may include a magnet arrangement including a plurality of magnets having different magnetization directions, and a central magnetic pole including a magnetic substance and at least partially located on an outer side with respect to the magnet arrangement in a radial direction.

According to an embodiment, the central magnetic pole may include an outer end portion at a side of the magnetic material portion and an inner end portion at a side of the magnet arrangement in the radial direction, and a width of the outer end portion may be less than a width of the inner end portion.

According to an embodiment, the width of the outer end portion of the central magnetic pole may be greater than a width of the magnetocaloric unit of the magnetic material portion.

According to an embodiment of the disclosure, when the central magnetic pole faces one of the plurality of magnetic material portions in the radial direction, a distance between a surface of the central magnetic pole and the magnetocaloric unit of another magnetic material portion adjacent to the magnetic material portion facing the central magnetic pole is greater than a distance between the surface of the central magnetic pole and the magnetocaloric unit of the facing magnetic material portion.

According to an embodiment of the disclosure, the plurality of magnets may include a first magnet, and second and third magnets that are arranged on the outer circumferential side of the first magnet in a circumferential direction based on the rotary shaft. A magnetization direction of the first magnet may be a radial direction based on the rotary shaft. Magnetization directions of the second and third magnets may be opposite to each other in the circumferential direction based on the rotary shaft. The central magnetic pole may be located between the second magnet and the third magnet.

According to an aspect of the disclosure, a magnetic cooling apparatus includes a rotating magnetic array device including a plurality of heat generators, and a cold energy extracting device that extracts cold energy when one of the plurality of heat generators generates the cold energy The rotating magnetic array device includes a magnetic field generator including a plurality of magnetic poles generating a magnetic field, and being rotatable about a rotary shaft; and a plurality of magnetic material portions including a plurality of heat generators generating heat energy and cold energy according to rotation of the magnetic field generator, and the plurality of magnetic material portions are arranged on a circumference based on the rotary shaft, so as to simultaneously include a first magnetic material portion facing a center of one of the plurality of magnetic poles, a second magnetic material portion facing one of the plurality of magnetic poles and not facing a center of the magnetic pole, and a third magnetic material portion facing a space between two of the plurality of magnetic poles.

According to an embodiment, an arrangement relationship between the plurality of magnetic material portions and the plurality of magnetic poles may not be in rotational symmetry.

According to an embodiment, the number of the plurality of magnetic poles may be a prime number.

According to an embodiment, the plurality of magnetic material portions may include at least one dummy that does not generate heat energy or cold energy. A magnetic susceptibility of the at least one dummy may be nearly equal to magnetic susceptibilities of the plurality of heat generators.

According to an embodiment, the magnetic cooling apparatus may include a magnetic susceptibility adjusting portion that changes a magnetic susceptibility of the at least one dummy according to a change in the magnetic susceptibility of the plurality of heat generators.

According to an embodiment, the magnetic susceptibility adjusting portion may change a magnetic susceptibility of a dummy facing one of the plurality of magnetic poles, from among the at least one dummy, when the magnetic field generator is rotated. According to the above-described embodiments, the plurality of magnetic poles and the plurality of magnetic material portions are arranged so that, around the plurality of magnetic poles that are rotating, a magnetic material portion facing a center of one of the plurality of magnetic poles, a magnetic material portion facing one of the magnetic poles but not facing the center of the magnetic pole, and a magnetic material portion facing between two of the plurality of magnetic poles may exist simultaneously. Accordingly, excessive concentration of magnetic flux may be prevented, and the torque pulsation of the motor rotating the plurality of magnetic poles is reduced by increasing to a higher order, and thus, the mechanical input to the rotating magnetic array device may be reduced.

It will be appreciated by one of ordinary skill in the art that that the objectives and effects that could be achieved with the disclosure are not limited to what has been particularly described above and other objectives of the disclosure will be more clearly understood from the following detailed description.

As described above, the rotating magnetic array device and the magnetic freezer system adopting the same according to the disclosure are described with reference to the embodiments and drawings, but the disclosure is not limited to the above embodiments, and may be variously modified within the scope of the disclosure.

1. A refrigerator comprising:
a main body provided with at least one storage chamber; and
a cold air supply apparatus provided with a rotating magnetic array device and a cold energy extracting device for extracting cold energy generated by the rotating magnetic array device, and supplying the cold energy to the storage chamber,
wherein the rotating magnetic array device comprises:
a magnetic field generator including a plurality of magnetic poles generating a magnetic field, and being rotatable about a rotary shaft; and
a plurality of magnetic material portions including a plurality of heat generators generating heat energy and the cold energy according to rotation of the magnetic field generator, and
the plurality of magnetic material portions are arranged on a circumference based on the rotary shaft, so as to simultaneously include a first magnetic material portion facing a center of one of the plurality of magnetic poles, a second magnetic material portion facing one of the plurality of magnetic poles and not facing a center of the magnetic pole, and a third magnetic material portion facing a space between two of the plurality of magnetic poles.

2. The refrigerator of claim 1, wherein an arrangement relationship between the plurality of magnetic material portions and the plurality of magnetic poles is not in rotational symmetry.

3. The refrigerator of claim 1, wherein a number of the plurality of magnetic poles is a prime number.

4. The refrigerator of claim 1, wherein the plurality of magnetic material portions include at least one dummy that does not generate the heat energy or the cold energy.

5. The refrigerator of claim 4, wherein a magnetic susceptibility of the at least one dummy is nearly equal to magnetic susceptibilities of the plurality of heat generators.

6. The refrigerator of claim 4, further comprising a magnetic susceptibility adjusting portion that changes a magnetic susceptibility of the at least one dummy according to a change in the magnetic susceptibility of the plurality of heat generators.

7. The refrigerator of claim 6, wherein the magnetic susceptibility adjusting portion changes a magnetic susceptibility of the at least one dummy so that a motor current for rotating the magnetic field generator is minimum.

8. The refrigerator of claim 6, wherein the magnetic susceptibility adjusting portion changes a magnetic susceptibility of a dummy facing one of the plurality of magnetic poles, from among the at least one dummy, when the magnetic field generator is rotated.

9. The refrigerator of claim 6, wherein the magnetic susceptibility adjusting portion changes the magnetic susceptibility of the at least one dummy by inserting a first amount of magnetic substance corresponding to a second amount of magnetic substance inserted in the plurality of heat generators into each of the at least one dummy.

10. The refrigerator of claim 1, wherein each of the plurality of magnetic poles comprises:
a magnet arrangement including a plurality of magnets having different magnetization directions; and
a central magnetic pole including a magnetic substance and being at least partially located on an outer side with respect to the magnet arrangement in a radial direction.

11. The refrigerator of claim 10, wherein
the central magnetic pole includes an outer end portion at a side of the magnetic material portion and an inner end portion at a side of the magnet arrangement in the radial direction, and a width of the outer end portion is less than a width of the inner end portion.

12. The refrigerator of claim 10, wherein the width of the outer end portion of the central magnetic pole is greater than a width of a magnetocaloric unit of the magnetic material portion.

13. The refrigerator of claim 10, wherein, when the central magnetic pole faces one of the plurality of magnetic material portions in the radial direction, a distance between a surface of the central magnetic pole and the magnetocaloric unit of another magnetic material portion adjacent to the magnetic material portion facing the central magnetic pole is greater than a distance between a surface of the central magnetic pole and the magnetocaloric unit of the facing magnetic material portion.

14. The refrigerator of claim 10, wherein the plurality of magnets comprise:
a first magnet;
second and third magnets that are arranged on an outer circumferential side of the first magnet so as to face each other in a circumferential direction based on the rotary shaft,
wherein a magnetization direction of the first magnet is in the radial direction based on the rotary shaft,
wherein magnetization directions of the second and third magnets are opposite to each other in the circumferential direction based on the rotary shaft, and
wherein the central magnetic pole is located between the second magnet and the third magnet.

15. A magnetic cooling apparatus comprising:
a rotating magnetic array device including a plurality of heat generators; and
a cold energy extracting device that extracts cold energy when one of the plurality of heat generators generates the cold energy,
wherein the rotating magnetic array device comprises:
a magnetic field generator including a plurality of magnetic poles generating a magnetic field, and being rotatable about a rotary shaft; and
a plurality of magnetic material portions including a plurality of heat generators generating heat energy and the cold energy according to rotation of the magnetic field generator, and
the plurality of magnetic material portions are arranged on a circumference based on the rotary shaft, so as to simultaneously include a first magnetic material portion facing a center of one of the plurality of magnetic poles, a second magnetic material portion facing one of the plurality of magnetic poles and not facing a center of the magnetic pole, and a third magnetic material portion facing a space between two of the plurality of magnetic poles.

16. The magnetic cooling apparatus of claim 15, wherein an arrangement relationship between the plurality of magnetic material portions and the plurality of magnetic poles is not in rotational symmetry.

17. The magnetic cooling apparatus of claim 15, wherein a number of the plurality of magnetic poles is a prime number.

18. The magnetic cooling apparatus of claim 15, wherein
the plurality of magnetic material portions include at least one dummy that does not generate the heat energy or the cold energy, and
a magnetic susceptibility of the at least one dummy is nearly equal to magnetic susceptibilities of the plurality of heat generators.

19. The magnetic cooling apparatus of claim 18, further comprising a magnetic susceptibility adjusting portion that changes a magnetic susceptibility of the at least one dummy according to a change in the magnetic susceptibility of the plurality of heat generators.

20. The magnetic cooling apparatus of claim 19, wherein the magnetic susceptibility adjusting portion changes a magnetic susceptibility of a dummy facing one of the plurality of magnetic poles, from among the at least one dummy, when the magnetic field generator is rotated.
